(19) United States
(12) Patent Application Publication
(10) Pub. No.: US 2026/0262646 A1
(43) Pub. Date: Sep. 10, 2026

(54) AQUEOUS FUNGICIDE FORMULATION IN CONCENTRATED SUSPENSION, PRODUCTION PROCESS OF SAID FORMULATION AND ITS USES

(71) Applicant: TECNOMYL BRASIL DISTRIBUIDORA DE PRODUTOS AGRÍCOLAS LTDA, Foz do Iguaçu (BR)

(72) Inventors: Jose Martin Avila TORRES, Asuncion (PY); Sally Daniela Silvero DÍAZ, Lambaré (PY); Vivian María Silvero VELÁZQUEZ, Lambaré (PY)

(73) Assignee: TECNOMYL BRASIL DISTRIBUIDORA DE PRODUTOS AGRÍCOLAS LTDA, Foz do Iguaçu, PR (BR)

(21) Appl. No.: 18/723,229

(22) PCT Filed: Dec. 15, 2023
(86) PCT No.: PCT/BR2023/050455

§ 371 Date: Jun. 21, 2024

(30) Foreign Application Priority Data
Dec. 29, 2022 (BR) 102022026950-5
Oct. 24, 2023 (BR) 102023022108-4

(51) Int. Cl. A01N 47/26; A01N 25/04; A01N 25/22; A01P 3/00

(52) U.S. Cl. CPC A01N 47/26; A01N 25/04; A01N 25/22; A01P 3/00

(57) ABSTRACT

The present invention relates to an aqueous formulation of a dithiocarbamate fungicide in concentrated suspension (SC), as well as a production process of said formulation. The formulation is especially applied to biological targets present in crops such as rice, bananas, potatoes, citrus, beans, apples, corn, roses, soybeans, tomatoes, wheat, or grapes. The formulation presents physicochemical stability and effectiveness equal to or better than existing fungicidal formulations in SC, being an alternative product for farmers. In this context, said formulation is free from a plurality of adjuvants, especially those defined as non-essential in the context of the present invention, and the used adjuvants are present in low concentrations. Furthermore, this formulation is also free from adjuvants that are toxic to biota, humans, and the environment. The production process, in turn, is an additional differential considering peculiarities such as the order of addition of components, the nature of the steps, the order in which they are executed, as well as the process variables involved.

The present utility patent application claims internal priority of process BR 10 2022 026950 5, filed on Dec. 29, 2022, under the terms of Law #9,279, of May 14, 1996.

### FIELD OF APPLICATION

The present invention is contained in the field of application of agronomic engineering, agricultural engineering, organic chemistry, physical chemistry, chemical engineering, botany, and biology.

More specifically, the present invention relates to an aqueous fungicide formulation in concentrated suspension comprising an active ingredient, dithiocarbamate, the production process of said formulation and its agronomic uses.

### DESCRIPTION OF THE STATE OF THE ART

When discussing agronomic formulations based on concentrated suspensions (SC), i.e., comprising active ingredients in high concentrations, one of the biggest challenges is the low physicochemical stability, the reduced solubility of pesticides, such as dithiocarbamate fungicides, and sedimentation leading to phase separation. In this context, there are aqueous formulations and oil dispersions (OD). In the latter, dithiocarbamates such as mancozeb are insoluble, which requires efforts in the correct choice and quantities of adjuvants capable of providing the desired physicochemical stability and, consequently, achieving high agronomic performance. This is because the added components are crucial to providing a stable composition, which would not be possible with the simple addition of dithiocarbamate itself to the oil. On the other hand, concentrated aqueous suspensions are more viable compared to those of the OD type, as dithiocarbamates present some solubility in this case, albeit reduced.

Evidently, OD or aqueous concentrated suspensions were developed for specific applications, i.e., they were not developed so that one outperforms the other. Indeed, there are cases in which the aqueous suspension is more recommended compared to the OD suspension, and vice versa. In this sense, the present invention directs efforts strictly towards solving problems in the state of the art related to aqueous concentrated suspensions, the challenges of which will be described in more detail below.

Although dithiocarbamates, especially mancozeb, present low solubility in water when compared to mostly hydrophobic solutions, this property is still insufficient for the formulation to have any agronomic performance, so that also for aqueous formulations the challenges related to physicochemical stability, phase separation, and hydrolytic degradation affect formulators. Such problems are inherent to the intra and intermolecular properties of mancozeb which, as it is a compound based on zinc and manganese metals complexed by organic molecules based on a dithiocarbamate, constitutes a strongly ionic chemical species. More specifically, the ionic strength in this case hinders the breakdown of electrostatic interactions, which would more easily favor the dispersion of the compound. Consequently, the solubility of this fungicide is low in water, even though it is an ionic compound. This molecular property also explains the insolubility of mancozeb in oil, i.e., it is a hydrophilic (ionic) compound which, as is known to those skilled in the art, is not soluble in hydrophobic solutions that constitute OD fungicidal formulations.

That said, the main challenges related to aqueous fungicide formulations in concentrated suspensions remain clear. In this context, the fungicidal agricultural inputs market directs efforts towards the continuous development of liquid mancozeb in concentrated suspension and reflects the plurality of patent and scientific prior art on this topic. When the focus is on solving physicochemical stability problems, which is one of the properties that directly reflect on application results, aqueous fungicide formulations in concentrated suspensions are developed through the choice of suitable adjuvants and their respective concentrations. In this context, there is an infinite choice for dispersants, thickeners, surfactants, preservatives, humectants, etc. and, therefore, each formulation is, in general, unique.

In the closest state of the art to the present invention, the prior art describes formulations presenting problems such as the use of components that promote agglomeration of dithiocarbamates, especially mancozeb, and petroleum-derived heavy aromatic adjuvants, which are harmful to the environment and significantly toxic to professionals who handle the product in the field, as well as producers. Furthermore, SC aqueous fungicidal formulations often include a plurality of secondary components that do not affect the effectiveness of the active ingredient, i.e., they are used as preservatives and related substances. Although they may indirectly contribute to the final properties of the formulation, some components may be dispensable from inclusion in the product, such as pH regulators and toxic solvents. Specifically in the case of preservatives, they do not contribute to effectiveness and may harm the biological action of the active ingredient. Ideally, the lowest amount (or absence) of adjuvants in agrochemical formulations while maintaining efficiency of use is desirable, especially when components harmful to the environment and toxic to humans and living beings are included. In this sense, simple formulations free from toxic components are a common objective in the fungicidal products market, with increasing efforts to develop efficient formulations, with reduced toxicity, simple and environmentally viable.

Still regarding the problems in the state of the art, especially regarding the documents that describe aqueous formulations of mancozeb as the only active ingredient and in the form of a concentrated suspension, teachings on the use of xanthan gum as a thickener are common. The use of this adjuvant promotes high viscosity in the formulations (a property inherent to this polysaccharide) and, in this sense, hinders the processing of the product during its manufacture and use due to the high resistance to flow. Xanthan gum is a polysaccharide based on D-glucose units in the main chain, said main chain being anchored by side chains based on trisaccharides, and said trisaccharide consisting of two mannose units separated by a glucuronic acid unit. The side chain of this gum provides the aforementioned high viscosity due to intermolecular steric effects, reducing movement between the polysaccharide polymer chains. Similarly, steric effects extend to dispersant polymers in the formulation, hindering their fluidity and, therefore, reducing the effect of increasing the dispersion of fungicidal particles-mancozeb particles, for example. To solve this problem, it is common to use highly concentrated dispersants to improve fluidity. Because of this property, in addition to requiring a high quantity of said adjuvant, said polysaccharide also limits the use of more than one type of dispersant, which would be desirable from the point of view of cooperative dispersant effects due to the presence of more than one dispersing polymer.

From the point of view of production processes for aqueous fungicide formulations in concentrated suspensions, these often adopt few steps involving mixing the components at once, which negatively affects the properties of the final formulation, as there is no effective control in homogeneity in these cases, which directly affects the obtaining of a finely divided dithiocarbamate dispersion and, consequently, the application effectiveness. Although the number of steps is reduced for most state-of-the-art processes, mancozeb fungicidal formulations require greater procedural robustness to obtain a homogeneous fluid comprising finely divided material. Furthermore, currently existing production processes lack quality control monitoring during progress, increasing the chances of obtaining non-standardized formulations and presenting the aforementioned technical deficiencies. For a better understanding of the problems in the state of the art mentioned herein, the closest prior art to the present invention will be described below, which disclose technologies presenting the problem discussed herein.

Document CN111972409 describes an aqueous formulation of mancozeb in concentrated suspension, and a production process of said formulation. Among the preferred examples of embodiment and closest to the present invention is a formulation comprising siloxane, concentrated mancozeb, dispersant based on a high molecular weight surfactant, sodium lignosulfonate, propylene glycol and citric acid. The technology disclosed in this document includes two types of dispersants which, when added together, total a high concentration in the formulation (at least 10% by mass). Although there are two dispersants, they are present in high quantities, highlighting the problem related to the high quantity of adjuvants to obtain formulations comprising the target physicochemical properties. More specifically, there is the problem of toxicity inherent to adjuvants, i.e., the greater their quantity, the greater the toxicity of the formulation as a whole. For comparison purposes, the toxicological effects of the active ingredient itself must be disregarded, since in the field of the present invention, mancozeb in state-of-the-art formulations present similar and high concentration ranges, as they fit into the context of formulations in concentrated suspension. More specifically, the toxicological contribution of this dithiocarbamate in the currently known formulations and in the present invention is the same. Therefore, the technical problem of formulations such as those described in CN111972409 also lies in the high concentration of adjuvants in the formulation as a whole, which requires efforts for its reduction and simultaneously, to maintain the final physicochemical properties, whether they are equal or better in relation to what already exists, are maintained.

Still in relation to document CN111972409, it discloses the SC formulation comprising adjuvants that do not contribute to agronomic performance, being included only to maintain it with the properties of interest. Concerning the antifreeze component (preferably propylene glycol) and pH regulator (citric acid and the like). Furthermore, propylene glycol is found in high quantities in all formulations described as preferred, being 12% by mass.

Document CN115067327 discloses a fungicide composition for slow release of mancozeb, said composition comprising the following components in percentage by mass: technical mancozeb 20-30%; slow-release agent 5-8%; dispersant 5-8%; suspending agent 1-2%; antifoam agent 0.5%-1%; preservative 0.1-0.3%; antifreeze 1-5%; and deionized water complementing 100%. In a first aspect, the composition described in the prior art comprises dispensable adjuvants, i.e., they are included only to maintain the final properties of the formulation, not directly contributing to its application effectiveness, said dispensable adjuvants being the antifreeze propylene glycol (2% in a preferred composition and closest to the present invention) and carbazone preservative (0.2% in a preferred composition and closest to the present invention). In a second aspect, said formulation comprises a dispersant which, in a preferred embodiment and closest to the present invention, is a polyoxypropylene/polyoxyethylene copolymer and in high concentration. In this context, in addition to this adjuvant being in considerable quantity, which contributes considerably to the toxicity of the formulation as a whole, it is the only dispersant present in the product. In a third aspect, the composition taught in this document comprises a mancozeb releasing agent. In this context, the technology described in CN115067327 focuses on solving the problem of lack of control over the mancozeb absorption, i.e., it has a different direction in relation to the present invention. The composition production process, in turn, comprises few steps involving the mixing of almost all components at once, these steps not being monitored from a quality control point of view.

Document IN-234049 discloses an aqueous formulation of mancozeb in concentrated suspension comprising xanthan gum as a thickener, sodium metabisulfite and hexamethylene tetramine (HMT) preservatives, dispersants such as naphthalene sulfonic acid condensate with formaldehyde and sodium lignosulfonate, ethylene glycol antifreeze, and mineral oil. Although it uses two dispersant components in low quantities, namely the aforementioned components based on naphthalene and the lignosulfonate, such components when used simultaneously in the same formulation promote low physicochemical stability, as taught in U.S. Pat. No. 4,804,399. Furthermore, components based on naphthalene derivatives are significantly toxic to humans, biota, and the environment. Additionally, the mentioned formulation comprises xanthan gum which, as discussed, reduces the fluidity of the dispersing agents, affecting the dispersion properties. Still regarding the use of this gum, document U.S. Pat. No. 4,804,399 also discloses that the use of polysaccharide gums in concentrated aqueous suspensions favors the formation of viscous sediments, being an additional problem concerning the physicochemical stability of the composition. Finally, the concentration of xanthan gum in the IN-234049 formulation, predominantly in the example embodiments, is significantly low, which reduces the final viscosity. Low viscosity formulations, when applied, have the disadvantages of reduced exposure time of the active ingredient on the biological target due to a greater probability of leaching. Finally, IN-234049 also describes a formulation production process involving few steps wherein the components are mixed at once and lack effective quality control to obtain standardized products.

In this way, the state of the art would clearly benefit from an aqueous fungicide formulation in concentrated suspension comprising few adjuvants, said adjuvants in low concentration, free from non-essential components such as preservatives, antifreezes and the like and free from xanthan gum, said formulation being stable from a physicochemical point of view and efficient in application. Furthermore, the previous technique would also have as benefit a formulation free from components that are toxic to humans, the environment and living beings, such as those derived from petroleum (heavy aromatic solvents, naphthalene, paraffin, hydrocarbons in general, etc.). In this sense, the present invention provides an alternative formulation, comprising results equal to or better than those already available, with a technical difference mentioned herein and also as a low-cost option.

Furthermore, an additional benefit of the present invention is a production process of the aqueous fungicide formulation in concentrated suspension, said process benefiting the state of the art in that it includes a plurality of steps and quality control essential for obtaining a stable, efficient, and standardized formulation.

### BRIEF DESCRIPTION OF THE INVENTION

In a first aspect, the present invention relates to an aqueous fungicide formulation in concentrated suspension, said formulation comprising the following components, in mass percentage (% m/m):
(a) 30 to 50% of a dithiocarbamate fungicide;
(b) 0.1 to 3% of a first dispersant, said first dispersant being an aliphatic ethoxylated alcohol of formula (I)

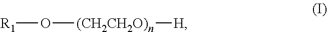

wherein R¹ is a linear or branched C₈-C₂₅ alkyl chain and “n” ranges from 1 to 10;
(c) 0.1 to 3% of a second dispersant, said second dispersant being a block copolymer of polyethylene glycol and polypropylene glycol of formula (II)

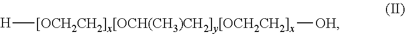

wherein “x” ranges from 80 to 135 and “y” ranges from 30 to 70;
(d) 0.1 to 2% of a thickener, said thickener being a cellulose derivative;
(e) 0.1 to 3% of an antifoam; and
(f) 50 to 65% water,
whereby said formulation is free from any of the following components:
(A) polysaccharide gum;
(B) naphthalene derivatives;
(C) pH regulators;
(E) antifreeze;
(F) petroleum-derived hydrocarbons;
(G) lignosulfonate salts; and
(H) formaldehyde.

In a second aspect, the present invention relates to a production process of the aqueous fungicide formulation in aqueous suspension such as described herein, said process comprising the following steps:
(a) in a formulating tank, adding water and start stirring using a mixer;
(b) adding the aliphatic ethoxylated alcohol of formula (I) in the water, and maintaining stirring; obtaining a first mixture;
(c) adding the block copolymer of polyethylene glycol and propylene glycol of formula (II) to the first mixture, and keep stirring; obtaining a second mixture;
(d) adding the antifoam to the second mixture, and keep stirring; obtaining a third mixture;
(e) adding the dithiocarbamate to the third mixture, said addition being carried out between 30 and 120 minutes, preferably 60 minutes, and keep stirring after the addition time of said dithiocarbamate; obtaining a fourth mixture;
(f) carry out grinding of the fourth mixture for 60 to 180 minutes, preferably 90 minutes, said grinding being carried out at temperatures between 2° and 30° C., preferably 25° C., and said grinding being carried out at a rotation frequency between 20 and 80 Hz, preferably between 30 and 70 Hz, more preferably between 40 and 60 Hz; obtaining a ground mixture comprising dithiocarbamate microparticles;
(g) carrying out a preliminary quality control of the ground mixture, said quality control comprising a particle size analysis (d₉₈) and a 325 mesh test for the dithiocarbamate microparticles;
(h) decide whether to repeat step (f) or proceed with step (i), said decision being based on the following conditions: if the particle size (d₉₈) is a value outside the range between 2 and 7 microns, repeat step (f); if the particle size (d₉₈) is 2 to 7 microns and the 325 mesh test shows zero or negligible retention of said microparticles, proceed with step (i);
(i) adding the cellulose derivative and the preservative to the mixture approved in step (h), and start stirring; obtaining the aqueous fungicide formulation in concentrated suspension; and
(j) carrying out a general quality control comprising the measurement of physicochemical parameters selected from the group including color, pH, density, foam, viscosity, particle size, 325 mesh test, 200 mesh test, suspensibility, mancozeb content and stability at 54° C., said parameters comprising the specifications described in table 2, said specifications defining the quality conditions by which the formulation obtained herein will present the desired physicochemical properties for effective agronomic performance.

In a third aspect, the present invention relates to the use of the aqueous fungicide formulation in aqueous suspension for application to biological targets present in crops selected from the group comprising rice, banana, potato, citrus, bean, apple, corn, rose, soybean, tomato, wheat, grape, sugar cane, or cotton.

### BRIEF DESCRIPTION OF THE DRAWINGS

The subject matter of this Invention will be completely clear in its technical aspects from the detailed description that will be made based on the figures listed below, in which:

FIG. 1: flowchart of the production process of the aqueous fungicide formulation in concentrated suspension.

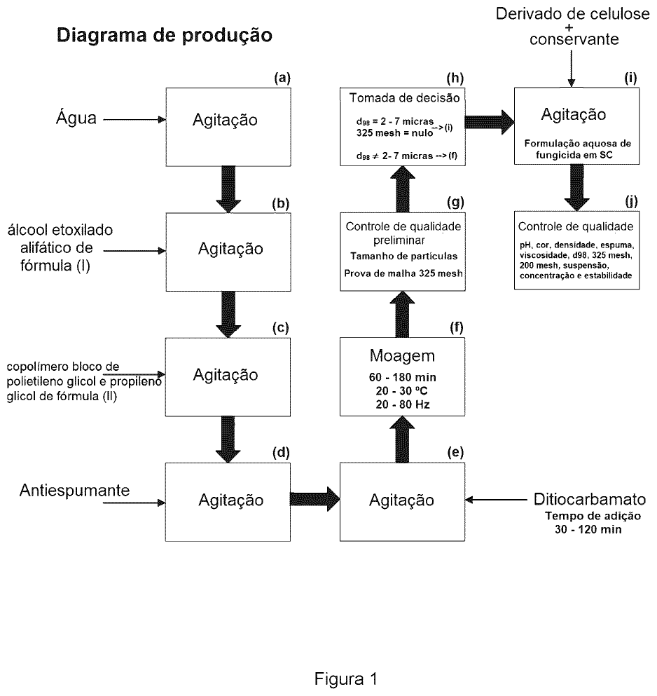

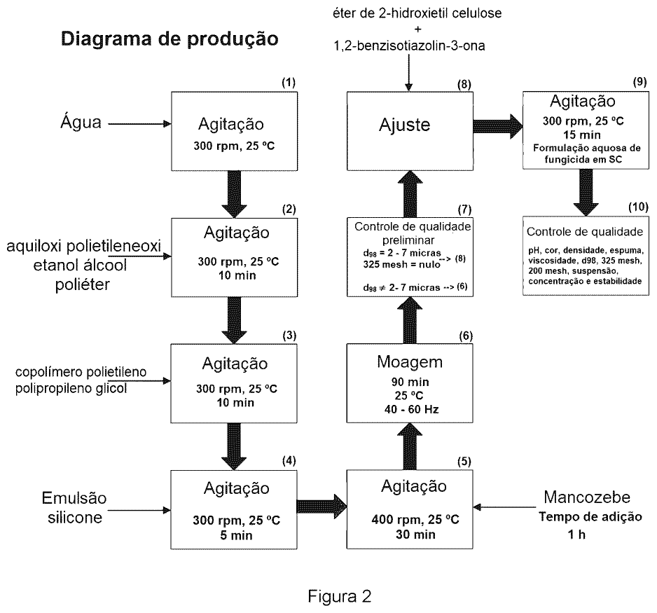

### DETAILED DESCRIPTION OF THE INVENTION

In accordance with the objectives presented by the brief description, in a first aspect the present invention relates to an aqueous fungicide formulation IN CONCENTRATED SUSPENSION, said formulation comprising the following components, in mass percentage (% m/m):
(a) 30 to 50% of a dithiocarbamate fungicide;
(b) 0.1 to 3% of a first dispersant, said first dispersant being an aliphatic ethoxylated alcohol of formula (I)

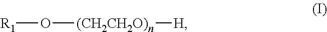

wherein R¹ is a linear or branched C₈-C₂₅ alkyl chain and “n” ranges from 1 to 10;
(c) 0.1 to 3% of a second dispersant, said second dispersant being a block copolymer of polyethylene glycol and polypropylene glycol of formula (II)

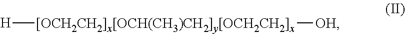

wherein “x” ranges from 80 to 135 and “y” ranges from 30 to 70;
(d) 0.1 to 2% of a thickener, said thickener being a cellulose derivative;
(e) 0.1 to 3% of an antifoam; and
(f) 50 to 65% water,
whereby said formulation is free from any of the following components:
(A) polysaccharide gum;
(B) naphthalene derivatives;
(C) pH regulators;
(E) antifreeze;
(F) petroleum-derived hydrocarbons;
(G) lignosulfonate salts; and
(H) formaldehyde.

For the purpose of better understanding the present invention, it should be understood that the dithiocarbamate fungicide is an active ingredient of the aqueous fungicide formulation in concentrated suspension and that the other components are called adjuvants. In this sense, active ingredient and adjuvant are called, each of them, components of said formulation. Still in relation to a better and precise understanding of what is described in the present specification, adjuvants are components that are mixed with the active ingredient in order to improve its agronomic effectiveness.

For the purpose of better understanding the present invention, the “aqueous fungicide formulation in concentrated suspension” described herein will alternatively be described simply as “formulation”. Therefore, whenever “formulation” is mentioned, it must be understood that it is an “aqueous fungicide formulation in concentrated suspension”.

In a non-restrictive embodiment of the present invention, the formulation comprises the following components, in mass percentage (% m/m):
(a) 35 to 45% of dithiocarbamate fungicide, preferably 38.2%;
(b) 0.8 to 1.5% of the aliphatic ethoxylated alcohol of formula (I), preferably 1.3%,
(c) 0.8 to 1.5% of the block copolymer of polyethylene glycol and polypropylene glycol of formula (II), preferably 1.4%;
(d) 0.1 to 1% of cellulose derivative, preferably 0.2%;
(e) 0.1 to 1% of antifoam, preferably 0.9%; and
(f) 55 to 60% of water, preferably 58%.

In a non-restrictive embodiment of the present invention, R₁ is a linear C₁₀-C₂₀ alkyl chain, preferably a linear C₁₂-C₁₆ alkyl chain, “n” ranges from 1 to 6, preferably from 1 to 3, “x” ranges from 90 to 110, preferably from 95 to 100, and “y” ranges from 55 to 70, preferably from 62 to 67.

In a non-restrictive embodiment of the present invention, the formulation additionally comprises a preservative in low concentration, said preservative being present in the formulation in amounts between 0.001 and 0.01% by mass (% m/m), preferably 0.005% (m/m).

In a non-restrictive embodiment of the present invention, dithiocarbamate is selected from the group comprising mancozeb, maneb, metiram, propineb, zineb, amobam, ferbam, tiram, or ziram, preferably mancozeb.

In a non-restrictive embodiment of the present invention the cellulose derivative is selected from the group comprising methyl cellulose, hydroxypropyl cellulose, hydroxypropyl methyl cellulose, hydroxyethyl cellulose, hydroxyethyl methyl cellulose, hydroxypropyl methyl cellulose, carboxymethyl hydroxyethyl cellulose, carboxymethyl cellulose, or carboxymethyl hydroxyethyl cellulose, preferably hydroxyethyl cellulose.

In a non-restrictive embodiment of the present invention, the antifoam is a silicone emulsion.

In a non-restrictive embodiment of the present invention, the preservative is selected from the group comprising 2-methyl-4-isothiazolin-3-one, 1,2-benzisothiazolin-3-one, 2-n-octyl-4-isothiazolin-3-one, 2-methyl-4-isothiazolin-3-one, 5-chloro-2-methyl-4-isothiazolin-3-one or n-octyl-isothiazolin-3-one, preferably 1,2-benzisothiazolin-3-one.

In a non-restrictive embodiment of the present invention, the polysaccharide gum is selected from the group comprising xanthan gum, guar gum, locust bean gum, tragacanth gum, arabic gum, gellan gum, carrageenan gum, ghatti gum, or karaya gum, preferably xanthan gum.

In a non-restrictive embodiment of the present invention, the naphthalene derivatives are selected from the group comprising naphthalene, naphthalene sulfonic acid condensate with formaldehyde, diisopropyl naphthalene sulfonic acid condensate with formaldehyde, alkyl naphthalene sulfonic acid condensate with formaldehyde, naphthalene sulfonic acid, sodium naphthalene sulfonate, diisopropyl naphthalene sulfonic acid, sodium diisopropyl naphthalene sulfonate, alkyl naphthalene sulfonic acid or sodium alkyl naphthalene sulfonate, preferably naphthalene sulfonic acid condensate with formaldehyde, naphthalene sulfonic acid, or sodium naphthalene sulfonate.

In a non-restrictive embodiment of the present invention, the pH regulators are selected from the group comprising propionic acid, sorbic acid, benzoic acid, citric acid, lactic acid, or acetic acid, preferably citric acid.

In a non-restrictive embodiment of the present invention, the antifreezes are preferably antifreeze glycols, said antifreeze glycols being selected from the group comprising propylene glycol, ethylene glycol, polyethylene glycol, or glycerol, preferably propylene glycol or ethylene glycol.

In a non-restrictive embodiment of the present invention, petroleum-derived hydrocarbons are selected from the group comprising aromatic solvents, naphthalene solvents, naphthalene oils, or paraffinic oils.

In a non-restrictive embodiment of the present invention, the lignosulfonate salts are selected from the group comprising sodium, calcium, or ammonium lignosulfonate, preferably sodium lignosulfonate.

Among the components mentioned as absent in the aqueous fungicide formulation in concentrated suspension, formaldehyde is the only one specifically described, i.e., it does not belong to a group of related components such as those in items (A)-(G). This is because formaldehyde is a significantly toxic compound, recognized as carcinogenic, mutagenic, and harmful to the skin. For this reason, this component is strictly controlled by numerous regulatory agencies around the world, such as in Brazil. Thus, unlike numerous aqueous SC formulations of dithiocarbamates known in the art, the formulation of the present invention does not comprise formaldehyde.

Considering the complete description of the formulation, whether from the point of view of the components themselves and their respective quantities, its difference in relation to the state of the art is clear, due to the reasons that will be described below.

In a first aspect, the formulation lacks non-essential adjuvants, such as pH regulators, antifreezes, buffers, preservatives and the like. This is because such components are not included for the improvement of agronomic performance, i.e., they do not alter the biological mechanisms of action of the active ingredient in the target organism. In this context, these components are included in state-of-the-art formulations only to maintain their physicochemical and agronomic properties, said properties being provided by the referred to herein as essential adjuvants, namely dispersants, antifoams, surfactants, humectants, and thickeners. These essential adjuvants improve the stability, biological availability, exposure time of the active ingredient to the target organism and leaf surface, and resistance to decomposition of said active ingredient during the residence time after application-such properties are often maintained and controlled by non-essential adjuvants which, in the aqueous fungicide formulation in concentrated suspension, are dispensable, so that their absence does not reduce efficiency. Indeed, the inventors of the present invention surprisingly conceived said formulation as being free from said non-essential adjuvants due to the nature of the chosen components and their respective amounts. Although the absence of the preservative in the formulation has been mentioned when it is indeed present, its concentration is irrelevant due to the fact that it is present in amounts between 0.001 and 0.01% by mass (% m/m), preferably 0.005%. Compared to state-of-the-art formulations, preservatives are 100 times more concentrated compared to the present invention and the amount of preservative in the formulation is negligible, having no influence on its ability to preserve and maintain the properties of said formulation over time. Thus, the minimal inclusion of the preservative in no way contributes to the preservative effect that is necessary for state-of-the-art formulations and dispensable in the present invention. The preservative was included in this irrelevant concentration because it is contained in the cellulose derivative (preferably hydroxyethyl cellulose). More specifically, the cellulose derivative is a pre-formulation of cellulose derivative+preservative, said preservative being essential only for the cellulose derivative prior to its addition to the formulation.

In a second aspect, the aqueous fungicide formulation in concentrated suspension is free of polysaccharide gum, especially xanthan gum. This is because this component, often used as a thickener, reduces the fluidity of the dispersants and, consequently, reducing the physicochemical stability. Furthermore, polysaccharide gums, in general, such as those mentioned herein, preferably xanthan gum, are known to promote sedimentation in super-concentrated fungicidal formulations, especially aqueous ones comprising dithiocarbamates such as mancozeb.

Considering the above, the aqueous fungicide formulation in concentrated suspension comprises only a few essential adjuvants, said adjuvants in reduced quantities, with reduced intrinsic toxicity, and environmentally friendly. Even with such characteristics, the formulation surprisingly showed equal or better physicochemical stability and agronomic performance in relation to state-of-the-art formulations. Consequently, in addition to solving the described technical problems, this formulation is an alternative for the consumer also from an economic point of view, since only 4% (m/m) thereof constitutes the aforementioned adjuvants. In this context, although the demand for mancozeb is similar in relation to existing SC formulations, the need for adjuvants is significantly reduced, reducing consumption. The amount of adjuvants discarded in the present invention was replaced by water.

In a second aspect, the present invention relates to a PRODUCTION PROCESS of the aqueous fungicide formulation in aqueous suspension as described herein, said process comprising the following steps:
(a) in a formulating tank, adding water and start stirring using a mixer;
(b) adding the aliphatic ethoxylated alcohol of formula (I) in the water, and maintaining stirring; obtaining a first mixture;
(c) adding the block copolymer of polyethylene glycol and propylene glycol of formula (II) to the first mixture, and keep stirring; obtaining a second mixture;
(d) adding the antifoam to the second mixture, and keep stirring; obtaining a third mixture;
(e) adding the dithiocarbamate to the third mixture, said addition being carried out between 30 and 120 minutes, preferably 60 minutes, and keep stirring after the addition time of said dithiocarbamate; obtaining a fourth mixture;
(f) carry out grinding of the fourth mixture for 60 to 180 minutes, preferably 90 minutes, said grinding being carried out at temperatures between 2° and 30° C., preferably 25° C., and said grinding being carried out at a rotation frequency between 20 and 80 Hz, preferably between 30 and 70 Hz, more preferably between 40 and 60 Hz; obtaining a ground mixture comprising dithiocarbamate microparticles;
(g) carrying out a preliminary quality control of the ground mixture, said quality control comprising a particle size analysis (d₉₈) and a 325 mesh test for the dithiocarbamate microparticles;
(h) decide whether to repeat step (f) or proceed with step (i), said decision being based on the following conditions: if the particle size (d₉₈) is a value outside the range between 2 and 7 microns, repeat step (f); if the particle size (d₉₈) is 2 to 7 microns and the 325 mesh test shows zero or negligible retention of said microparticles, proceed with step (i);
(i) adding the cellulose derivative and the preservative to the mixture approved in step (h), and start stirring; obtaining the aqueous fungicide formulation in concentrated suspension; and
(j) carrying out a general quality control comprising the measurement of physicochemical parameters selected from the group including color, pH, density, foam, viscosity, particle size, 325 mesh test, 200 mesh test, suspension level, mancozeb content, and stability at 54° C., said parameters comprising the specifications described in table 2, said specifications defining the quality conditions by which the formulation obtained herein will present the desired physicochemical properties for effective agronomic performance.

It should be understood that the dithiocarbamate, the aliphatic ethoxylated alcohol of formula (I), block copolymer of polyethylene glycol and propylene glycol of formula (II), the cellulose derivative, the antifoam and the preservative mentioned in the description of the production process for the aqueous fungicide formulation in concentrated suspension are as described herein in the present specification, especially in the description of the formulation. Therefore, the components mentioned in this embodiment of the invention must be interpreted based on what has already been described herein, and a detailed description below is dispensable.

In the following description, one of the aspects that will be mentioned concerns the added amounts of the components throughout steps (a) to (j). In this sense, said amounts are those specified for the formulation itself. In other words, it concerns the amounts of the components in the final formulation, as described herein and as shown in table 1.

The stirring mentioned throughout steps (a) to (j) in any of the embodiments described herein is carried out by a stainless-steel mixer equipped with a disc-type stirring system (shear). In this context, the stirring speed is controlled until the formation of a vortex, which is of extensive knowledge for a person skilled in the art. In a non-restrictive embodiment of the present invention, the stirring mentioned in any of the steps described herein is carried out at speeds between 300 and 800 rpm, preferably between 300 and 600 rpm, more preferably between 300 and 400 rpm, said stirring being carried out at temperature from 13 to 37° C., preferably 25° C.

In a non-restrictive embodiment of the present invention, the stirring mentioned in steps (a), (b) and (c) is carried out for 1 to 40 minutes, preferably for 5 to 25 minutes, more preferably for 10 minutes.

In a non-restrictive embodiment of the present invention, the stirring mentioned in step (d) is carried out for 1 to 20 minutes, preferably for 1 to 10 minutes, more preferably for 5 minutes.

In a non-restrictive embodiment of the present invention, the stirring mentioned in step (e) is carried out for 3 to 120 minutes, preferably for 15 to 60 minutes, more preferably for 30 minutes.

In a non-restrictive embodiment of the present invention, the stirring mentioned in step (i) is carried out for 1 to 60 minutes, preferably for 8 to 30 minutes, more preferably for 15 minutes.

In step (a) water is added in amounts between 55 and 60% (m/m), preferably 58% (m/m).

In step (b) the aliphatic ethoxylated alcohol of formula (I) is added in amounts between 0.8 and 1.5% (m/m), preferably 1.3% (m/m). The first mixture formed herein in this step comprises water and said aliphatic ethoxylated alcohol of formula (I).

In step (c) the block copolymer of polyethylene glycol and propylene glycol of formula (II) is added in amounts between 0.8 and 1.5% (m/m), preferably 1.4% (m/m). The second mixture formed in this step comprises water, aliphatic ethoxylated alcohol of formula (I), and said block copolymer of polyethylene glycol and propylene glycol of formula (II).

In step (d) the antifoam is added in amounts between 0.1 and 1% (m/m), preferably 0.9% (m/m). The third mixture formed in this step comprises water, aliphatic ethoxylated alcohol of formula (I), block copolymer of polyethylene glycol and propylene glycol of formula (II), and said antifoam.

In step (e) dithiocarbamate is added in amounts between 35 and 45% (m/m), preferably 38.2% (m/m). The fourth mixture formed in this step comprises water, aliphatic ethoxylated alcohol of formula (I), block copolymer of polyethylene glycol and propylene glycol of formula (II), antifoam, and said dithiocarbamate.

Step (f) is optionally carried out by alternative, state-of-the-art methods, provided that the dithiocarbamate has a particle size (d₉₈) between 2 and 7 microns and is not retained in 325 mesh.

Still regarding step (f), grinding can be carried out in three types of mills, namely: vertical immersion mill (laboratory scale); horizontal bead mill (production); or vertical immersion mill (production).

In step (i) the cellulose derivative is added in amounts between 0.1 and 1% (m/m), preferably 0.2% (m/m). The preservative, in turn, is added in amounts between 0.001 and 0.01% by mass (m/m), preferably 0.005% (m/m).

Step (j) is essential and one of the main differences in the production process of the formulation described herein, since it is directly correlated with the agronomic performance and standardization of the obtained product. More specifically, this step determines the specifications that the formulation must meet so that the surprising technical effect discovered by the inventors of the present invention is achieved by a person skilled in the art in possession of the present description of the specification.

As noted, the production process described herein comprises a plurality of steps showing the individual addition of each component followed by stirring and so on. Unlike the state of the art, wherein the processes comprise the simultaneous addition of components in a respective step, in the present invention said additions occur individually and successively, configuring a differential. As mancozeb, the preferred dithiocarbamate of the present invention, presents little solubility in water and is also prepared in high concentrations, the described production process provides individualized steps, favoring greater homogeneity and ease of dispersion. The order of addition for each of the components contributes to this characteristic, which will be better described below.

The initial addition of the aliphatic ethoxylated alcohol of formula (I) to water and the block copolymer of polyethylene glycol and propylene glycol of formula (II) is essential for a homogeneous premix. This is because the hydrophilic part of said components comprises hydroxyl groups that interact strongly with water through hydrogen bonds, forming stable micelles. This is supported by the fact that each of these components are added individually, i.e., first the aliphatic ethoxylated alcohol of formula (I) is added, followed by stirring. At this moment, there is a homogeneous and stable mixture. Subsequently, said copolymer is added, followed by stirring. In this situation, there are the aforementioned hydrogen interactions, favoring the subsequent addition of the antifoam, which acts as a surfactant together with the two components mentioned herein, as these three components each have a hydrophilic and a hydrophobic portion.

Next, dithiocarbamate is added using a specific procedure. The addition is gradual and must be carried out within the time period mentioned herein, preferably according to the preferred process example described below. The gradual addition following the mentioned addition time favors the easy solubilization of the active ingredient as it is included in the fluid. Therefore, the inventors of the present invention have discovered that the stirring time can be the one already included in the process description or the one in the preferred embodiment below. After this step, dithiocarbamate is relatively stable from a physicochemical point of view. To further improve this property, the grinding step was necessary, as long as the conditions described herein were respected, preferably those of the embodiment examples below. The thickener is added only at the end of the process, since the fluid is already homogeneous within what was surprisingly discovered by the inventors.

Finally, the obtained formulation must present the specifications described in table 2 in order to comprise the achieved agronomic performance. It is important to mention that in addition to the inherent characteristics of the production process described herein, the formulation needs to comprise the components as described for the formulation and also in the concentrations determined in the present invention. A person skilled in the art intended to change each of them, removing, adding and/or altering the concentration, will also need to develop a new production process. In other words, the nature of the aqueous fungicide formulation in concentrated suspension and its production process are directly dependent, configuring a mutual differential for obtaining an effective product. Thus, the technical difficulty of the present invention with regard to the design of a formulation with the aforementioned differential, and comprising equal or better performance in relation to the state of the art, remains clear.

In a third aspect, the present invention relates to the USE of the aqueous fungicide formulation in aqueous suspension for application to biological targets present in crops selected from the group comprising rice, banana, potato, citrus, bean, apple, corn, rose, soybean, tomato, wheat, grape, sugar cane, or cotton.

For each of the crops mentioned herein, the respective biological targets are as described herein in italics below:
(a) rice: Pyricularia grisae which causes the Brusone disease;
(b) banana: Mycosphaerella musicola which causes the Sigatoka leaf spot disease; and Mycosphaerella fijiensis which causes the black Sigatoka disease;
(c) potato: Alternaria solani which causes the black spot disease; and Phytophthora infestans which causes the late blight disease;
(d) citrus: Phyllocoptruta oleivora which causes the false rust mite disease; Diaporthe citri which causes the Melanose disease; and Elsinoe australis which causes the Sweet orange scab disease;
(e) bean: Colletotrichum lindemuthianum which causes the Anthracnose disease;
(f) apple: Venturia inaequalis for the Scabies disease; and Colletotrichum gloeosporioides for Bitter rot disease;
(g) corn: Phaeosphaeria maydis for Leaf spot disease; Puccinia polysora for the Southern corn rust disease; and Cercospora zeae maydis for Gray leaf spot disease
(h) rose: Diplocarpon rosae for Rose black spot disease;
(i) soy: Septoria glycines for Septoria brown spot disease; Corynespora cassiicola for Target spot disease; Phakopsora pachyrhizi for Asian soybean rust disease; and Colletotrichum truncatum for anthracnose disease;
(j) tomato: Alternaria solani for black spot disease; and Phytophthora infestans for late blight disease;
(k) wheat: Bipolaris sorokiniana for the disease Helmintosporiosis; and Pyricularia grisea for Brusone disease;
(l) grape: Plasmopora viticola for downy mildew disease;
(m) sugar cane: Thielaviopsis paradoxa for pineapple rot disease; and Puccinia Kuehnii for orange rust disease; and
(n) cotton: Corynespora cassiicola for target spot disease; and Ramularia areola for Ramularia leaf blight disease.

Considering the above, an aqueous fungicide formulation in concentrated suspension is applied in biological targets selected from the group comprising Pyricularia grisae, Mycosphaerella musicola, Mycosphaerella fijiensis, Alternaria solani, Phytophthora infestans, Phyllocoptruta oleivora, Diaporthe citri, Elsinoe australis, Colletotrichum lindemutianum, Venturia inaequalis, Colletotrichum gloeosporioides, Phaeosphaeria maydis, Diplocarpon rosae, Septoria glycines, Corynespora cassiicola, Alternaria solani, Bipolaris sorokiniana, Plasmopora viticola, Greeneria uvicola, Phakopsora pachyrhizi, Colletotrichum truncatum, Thielaviopsis paradoxa, Puccinia Kuehnii, Puccinia polysora, Cercospora zeae maydis, Corynespora cassiicola, or Ramularia areola. As the description itself suggests, said biological targets are fungi present in said crops, said fungi causing, respectively, the aforementioned diseases.

### EXAMPLES

In the following, preferred examples by which the present invention is conceived by the person skilled in the art will be described. However, such examples do not limit the scope of protection of the present invention and are disclosed here only for the purpose of better understanding it.

### Example 1

A preferred and non-restrictive example of the present invention is the aqueous fungicide formulation in concentrated suspension comprising the components and respective concentrations, as described in table 1.

TABLE 1
aqueous fungicide formulation in concentrated suspension
in a preferred example, said example showing the respective
concentrations (C) of each of the components and their functions.

| | | | (C) | | (C) |
|---|---|---|---|---|---|
| | | | (% | (C) | (% |
| Component | CAS | Function | m/V) | (g/L) | m/m) |
| Water | 7732- | Solvent | 67.35 | 673.5 | 57.925 |
| | 18-5 | | | | |
| Aquioxypolyethyl- | 68551- | Dispersant 1 | 1.5 | 15 | 1.3 |
| eneoxyethanol | 12-2 | | | | |
| alcohol polyether | | | | | |
| Polyethylene- | 9003- | Dispersant 2 | 1.7 | 17 | 1.4 |
| polypropylene glycol | 11-6 | | | | |
| copolymer | | | | | |
| Silicone emulsion | 159002- | Antifoam | 1.0 | 10 | 0.86 |
| | 21-8 + | | | | |
| | 25322- | | | | |
| | 69-4 | | | | |
| Mancozeb TC-purity | 94-75-7 | Active | 44.5 | 445 | 38.3 |
| greater than 85% | | ingredient | | | |
| 2-hydroxyethyl | 9004- | Thickener | 0.24 | 2.4 | 0.21 |
| cellulose ether | 62-0 | | | | |
| 1,2-benzisotiazolin- | 2634- | Preservative | 0.006 | 0.06 | 0.005 |
| 3-one | 33-5 | | | | |

Aquioxypolyethyleneoxyethanol alcohol polyether is preferably from the brands Genapol LA 070 or Dehydol LT7.
The polyethylene-polypropylene glycol copolymer is preferably from the brands Genapol PF 40 or Pluronic PE 6400.
The silicone emulsion is preferably from the brands SAG 1572, STRUKTOL SB 2071, AE SILAGRO 100 or TL-56N.
2-hydroxyethyl cellulose ether is preferably from the brand NatrosoITM 250.
1,2-benzisothiazolin-3-one is preferably from the brands Proxel GL 20; Acticide DB20; Nipacide BIT 20; IPEL BP 20.

### Example 2

For purposes of better understanding this example, which refers to the description of the production process of the aqueous fungicide formulation in aqueous suspension, the quantities of the components described herein are exactly those as described in table 1, and in any of the specific units of measurement (% m/m, % m/V or g/L).

In this preferred and non-restrictive example, the production process of the aqueous fungicide formulation in concentrated suspension comprises the following steps:
(1) adding water to a production line mixer, said water being added in the amount specified in table 1, and start stirring at a rate of 300 rpm at 25° C.;
(2) adding the aquioxypolyethyleneoxyethanol alcohol polyether, and stirring the mixture for 10 minutes, maintaining the stirring rate at 300 rpm at 25° C.—the amount of aquioxypolyethyleneoxyethanol alcohol polyether is as specified in table 1;
(3) adding the polyethylene-polypropylene glycol copolymer, and stirring the mixture for 10 minutes, maintaining the stirring rate at 300 rpm at 25° C.—the amount of polyethylene-polypropylene glycol copolymer is as specified in table 1;
(4) adding the silicone emulsion, and stir the mixture for 5 minutes, keep the stirring rate at 300 rpm at 25° C.—the amount of silicone emulsion is as specified in table 1;
(5) increasing the stirring rate to 400 rpm, maintaining the temperature at 25° C., adding the mancozeb so that it is added to the mixer for 1 hour and, immediately after the addition time (1 hour), maintain the stirring at 400 rpm at 25° C. for 30 minutes—the amount of mancozeb is as specified in table 1;
(6) transferring the mixture from step (5) to a mill tank and carrying out grinding for 90 minutes or until obtaining mancozeb particles comprising diameter (d₉₈) between 2 and 7 microns, said grinding being carried out at 25° C., and said grinding being carried out using a rotation frequency between 40 and 60 Hz;
(7) checking the particle size on an analyzer, and parallel control on 325 mesh; if the obtained values meet the physicochemical parameters in table 2, proceed to step (8); otherwise, repeat step (6);
(8) adjusting the viscosity and density of the formulation by adding 2-hydroxyethyl cellulose ether in an appropriate amount to achieve the respective viscosity and density ranges described in table 2; and adding 1,2-benzisothiazolin-3-one—the “appropriate amount” of 2-hydroxyethyl cellulose ether is that which is equal to or less than according to table 1, as there is the possibility of achieving the aforementioned viscosity and density in a smaller amount than that described in table 1 for said thickener; the amount of 2-benzisothiazolin-3-one, in turn, is as specified in table 1;
(9) stirring the mixture from step (8) for 15 minutes at a stirring rate of 300 rpm at 25° C.; obtaining the aqueous fungicide formulation in concentrated suspension, said fungicide being mancozeb at a concentration of 445 g/L in water; and
(10) carrying out the physicochemical/chromatographic control of the formulation through quality control and subsequent approval, said approval being conditioned to the formulation (product) meeting all the physicochemical parameters described in table 2.

The physicochemical parameters mentioned in the description of steps (7), (8), and (10) are described in table 2, said parameters being used as quality control.

TABLE 2
physicochemical parameters controlled in steps (7), (8) and (10).

| PHYSICOCHEMICAL | |
|---|---|
| PARAMETER | ACCEPTANCE RANGE |
| Appearance | Homogeneous suspension |
| | without phase separation |
| Color (according to | 602C/608C/609 C/461C |
| Pantone 2016 edition) | |
| pH | 5.50-8.00 |
| Density (g/mL) | 1.2700-1.3100 |
| Foam (mL, field) | max. 50 mL in 1 minute. |
| Viscosity (seconds) | 20-40 |
| Particle size (d98, microns) | 2-7 |
| 325 mesh test | No waste or negligible |
| 200 mesh test | No waste or negligible |
| Suspensibility (% m/m) | It should not be less than 75% |
| Amount of Mancozeb (% m/V) | 42.27-46.72 |
| Stability at 54° C. | It should not form a compact mass; if |
| | there is phase separation, it must be |
| | easily homogenized by stirring |

The inventors of the present invention discovered that for the surprising technical effect in field application to be achieved, the formulation must present the physicochemical parameters within the acceptance ranges described in table 2. By “surprising technical effect” in the context of the present invention, it must be understood that it is the formulation described herein comprising similar or better results in relation to the state of the art. As it presents a technical effect that may be similar to what already exists, the aqueous fungicide formulation in aqueous suspension also ends up being an alternative formulation for the final consumer (farmers, etc.), as this alternative aims to solve the problems of the state of the art (already mentioned) by presenting the following technical solutions:
presence of few adjuvants, said adjuvants in low concentration;
absence of non-essential components such as preservatives, antifreezes and the like;
absence of xanthan gum; and
absence of components that are toxic to humans, the environment, and living beings, such as those derived from petroleum (heavy aromatic solvents, naphthalene, paraffin, hydrocarbons in general, etc.).

Considering the above, even with the removal of key components, making the formulation simpler, reducing the concentration of adjuvants, and removing xanthan gum, the formulation obtained herein was still capable of presenting agronomic performance equal to or better than the prior art. In an attempt to obtain a formulation like this, the person skilled in the art would easily design an inefficient formulation, as the removal of adjuvants and reduction in the concentration of the remainder favors obtaining a low-effectiveness product. Faced with this technical difficulty, the inventors of the present invention surprisingly designed the formulation with the characteristics mentioned above while maintaining the application results expected by the consumer who benefits from this object of the present invention. Such characteristics are a reflection of the appropriate choice and quantity of each of the components, as well as the execution of an adequate production process to obtain the formulation.

As one of the ways to better highlight the difference of the present invention, the physicochemical stability tests of the aqueous fungicide formulation in concentrated suspension and their respective achieved results will be described below.

### Physicochemical Stability Studies

The aim of this study was to determine the thermal and air stability of the aqueous fungicide formulation in concentrated suspension, assessing the active ingredient content after 14 days of incubation at 54±2° C.

### Experimental Procedure

Formulation Incubation at 54±2° C. 62.0 g of the formulation was weighed into a vial with a lid and then incubated at 54±2° C. for a period of 14 days in the dark.

### Formulation Maintained at 25±1° C.

60.4 g of the formulation was weighed into a vial with a lid and then kept at 25±1° C. for a period of 14 days.

### Determination of the Active Ingredient

### Preparation of Solutions

Lead acetate solution (10% m/v): 20.0013 g of lead acetate was weighed in a 100 mL vial and transferred to a 200 ml volumetric flask. It was dissolved and the volume was completed with ultrapure water.

Potassium hydroxide solution (2 mol·L⁻¹): 56.1101 g of potassium hydroxide were weighed. It was dissolved in approximately 250 ml of methanol. After cooling, the solution was transferred to a 500 mL volumetric flask and the volume was measured with methanol. The solution was filtered through a vacuum pump system.

Ethanolic phenolphthalein solution (0.5% m/v): Approximately 0.253 g of phenolphthalein was weighed into a 50 mL volumetric flask. 30 ml of ethanol was added and the solution was homogenized. The volume was measured with ultrapure water.

Acetic acid solution (30% v/v): About 60 ml of glacial acetic acid was diluted in a 200 mL volumetric flask. The volume was completed with ultrapure water and the solution was homogenized.

Tetrasodium EDTA solution (34% m/v): Approximately 38.9336 g of tetrasodium EDTA was weighed into a 100 mL vial, approximately 50 ml of ultrapure water was added, and the solution was homogenized. The solution was transferred to a 100 mL volumetric flask and the volume was completed with ultrapure water.

Sulfuric acid solution (1.1 N): Approximately 16.5 mL of sulfuric acid was diluted in a 500 ml volumetric flask. The volume was completed with ultrapure water and the solution was homogenized.

Starch solution (1% m/v): Approximately 2.0014 g of soluble starch was weighed into a 100 mL vial and 20 mL of ultrapure water was added. The solution was transferred to a 250 ml vial with approximately 20 mL of boiling ultrapure water and the solution was homogenized. After cooling, the solution was transferred to a 200 mL volumetric flask and the volume was measured with ultrapure water.

### Procedure

A condenser was connected to the distillation flask and cooled. Approximately 25 mL of lead acetate solution (10% m/v) was added to the first absorber. This absorber is connected to the distiller. Approximately 25 ml of methanolic potassium hydroxide solution (2 mol·L⁻¹) was added to the second and third absorbers, and the glass material was cooled. The thermostatic bath water began to flow and the absorbers were connected.

About 0.2 g (Table 3) of the formulation was weighed and transferred to a 250 ml decomposition flask. About 10 ml of tetrasodium EDTA solution (34% m/v) was added to this flask and the solution was stirred until the sample dispersed. The decomposition vial was connected to the condenser and placed on the heating mantle.

The top of the third absorber was connected to the vacuum pump, with a flow rate of 120-360 bubbles per minute. Then, about 50 ml of sulfuric acid solution (1.1 N) was added at the boiling point through the decomposition flask on the inlet side. The heating mantle was turned on and when the solution became clear (clearer), the heating was reduced. The reflux was maintained for exactly 105 minutes from the start of heating. Then the heating blanket was removed and the decomposition flask was disconnected.

The absorbers containing the methanolic potassium hydroxide solution were disconnected and their contents were transferred to 500 ml Erlenmeyers using 250 ml of ultrapure water. Three drops of phenolphthalein (0.5% m/v ethanolic solution) were added to the Erlenmeyer vials containing the final solution and were neutralized with acetic acid solution (30% v/v). The neutralized solution was immediately titrated with iodine solution (0.1 N) until the color of the solution turned yellow. Then, 5 ml of starch solution (1% m/v) was added and the titration was continued until the end point was bluish in color. This procedure was carried out in triplicate.

### Calculations

The concentration of mancozeb (% C₁ (m/m)) in the formulation was calculated based on the equation below:

$$\% {C}_{1 ( m / m )} = [ ( AB ) \times N \times 0.13551 ] / m , \qquad Equation 1$$

Where:
C₁=concentration of Mancozeb in the formulation in % (m/m);
A=volume of iodine solution consumed in the titration of the formulation (mL);
B=volume of iodine solution consumed in the blank titration (mL);
N=the molarity of the iodine solution=0.1 N;
Mancozeb Factor=0.13551;
m=mass of the formulation (g).

$${C}_{2 ( g . L - 1 )} = \% {C}_{1 ( m / m )} \times 10 \times d , \qquad Equation 2$$

where:
d=density of the formulation (1.1972 g·cm⁻³).

The degradation of the formulation resulting from incubation was calculated by the following equation:

$${D}_{f ( \% )} = \{ [ {C}_{Al 25} - {C}_{Al 54} ] / {C}_{Al 25} \} \times 100 , \qquad Equation 3$$

where:
D_{f}—degradation of the formulation;
C_{AI54} (formulation maintained at 25±1° C.)—average mancozeb content from the initial analysis of the formulation; and
C_{AI54} (formulation incubated at 54±2° C.)—average mancozeb content of incubated samples of the formulation.

The arithmetic mean (u) was determined by the equation below:

$$μ = ( {x}_{1} + {x}_{2} + … + {x}_{n} ) / n = {\sum }_{x i} / n , \qquad Equation 4$$

where:
p=arithmetic mean of values;
xᵢ=obtained values; and
n=number of obtained values.

The standard deviation(s) was calculated according to the following equation:

$$s = {[ Σ ( x i - μ ) / ( n - 1 ) ]}^{1 / 2} \qquad Equation 5$$

The relative standard deviation (DPR) was calculated according to the following equation:

$$DPR \% = ( s / μ ) \times 100 \qquad Equation 6$$

where:
s=standard deviation; and
μ=arithmetic mean of the values.

### Results

TABLE 3
analysis of mancozeb in the formulation maintained at 25 ± 1° C. and 54 ± 2° C.

| | | | Volume of | Volume of | | |
|---|---|---|---|---|---|---|
| | | | iodine | iodine | | |
| | | | solution | solution | | Average |
| | | Formulation | consumed in | consumed in | Mancozeb | Mancozeb |
| | | mass | the blank B | formulation A | content | content |
| Conditions | Rate | (g) | (mL) | (mL) | g · L⁻¹ | C_{Al} / g · L⁻¹ |
| Formulation | 1 | 0.2124 | 0.2 | 5.8 | 427.73 | 427.03 |
| maintained at | 2 | 0.2063 | | 5.6 | 424.65 | |
| 25 ± 1° C. | 3 | 0.2157 | | 5.9 | 428.71 | |
| | 1 | 0.2184 | 0.2 | 5.9 | 423.41 | 426.1 |
| Formulation | 2 | 0.2319 | | 6.3 | 426.74 | |
| maintained at | 3 | 0.2122 | | 5.8 | 428.13 | |
| 54 ± 2° C. | | | | | | |

Table 4 shows the degradation of the formulation, calculated from the determined average of mancozeb content in the formulation maintained at 25±1° C. and incubated at 54±2° C. for 14 days.

TABLE 4
Degradation of mancozeb 445 SC after 14 days of
incubation at 25 ± 1° C. and 54 ± 2° C.

| | Average mancozeb | Mancozeb |
|---|---|---|
| | content | Degradation |
| Formulation | C_{AL}/g · L⁻¹ | Df/% |
| Formulation maintained at 25 ± 1° C. | 427.03 | 0.22 |
| Formulation maintained at 54 ± 2° C. | 426.1 | |

According to CIPAC MT 46.3 (2017) (Collaborative International Pesticides Analytical Council), the aqueous pesticide formulation in concentrated suspension is considered stable at normal storage temperatures for a period of at least 2 years, if, following incubation for 14 days at 54±2° C., its content characteristics remain unchanged or do not differ by more than 5% from the initial analysis.

### Example 3

### Comparative Physicochemical Stability Studies (Reference RN 9530).

The present study aims to demonstrate the advantages of using 2% hydroxyethyl cellulose compared to xanthan gum when used as a thickener in the aqueous fungicide formulation in concentrated suspension. For the purpose of better understanding the studies described below, the aqueous fungicide formulation in concentrated suspension will henceforth be referred to as mancozeb formulation 44.5% SC.

A 6-liter formulation of the mancozeb formulation 44.5% SC was made, which was divided into two to cover a single variable, in this case the thickener. The formulations were named M1 and M2, which are:
M1: mancozeb formulation 44.5% SC with 2% hydroxyethyl cellulose as thickener; and
M2: mancozeb formulation 44.5% SC with 2% xanthan gum as thickener.

Stability studies were conducted at temperatures of zero, 3° C. and 54° C., where:
T=0: stability test at temperature and ambient conditions;
T=3° C.: stability test in a climatic chamber at 3° C. for 7 days: simulates the climatic conditions of places with low temperatures; and
T=54° C.: stability test in an oven at 54° C. for 14 days: simulates expiration conditions of approximately 2 years.

TABLE 5
physicochemical results for the mancozeb formulation with
44.5% SC containing hydroxyethyl cellulose.

| | | T = 3° C. | T = 54° C. |
|---|---|---|---|
| Concentrated | T = 0 | 7 days | 14 days |
| suspensions | M1 | M1 | M1 |
| Appearance | Homogeneous | Homogeneous | The formulation |
| | suspension | suspension | compacts and |
| | without phase | without phase | darkens on the |
| | separation and | separation and | surface but |
| | sediments | sediments | redisperses with |
| | | | vigorous stirring. |
| | | | The rod passes |
| | | | through the soft |
| | | | paste without |
| | | | difficulty when |
| | | | inserted. |
| | | | No lumps or |
| | | | sediments are |
| | | | present. |
| Color | 608 U | 608 U | 608 U |
| pH | 6.42 | 6.39 | 5.89 |
| formulation | | | |
| Density | 1.2489 g/mL | 1.2461 g/mL | 1.2584 g/mL |
| Foam | Stops at | Stops at | Stops at |
| | less than 10 sec. | less than 10 sec. | less than 10 sec. |
| Viscosity | 17,19 s | 18,50 s | 115,65 s |
| Particle size | D 50: 1.587 | D 50: 1.691 | D 50: 3.215 |
| | D 90: 2.895 | D 90: 2.802 | D 90: 4.362 |
| | D 98: 4.985 | D 98: 5.874 | D 98: 6.814 |
| 200 Mesh test | No waste | No waste | No waste |
| Suspensibility | 90.23% | 89.54% | 82.68% |

TABLE 6
physicochemical results for the mancozeb formulation with
44.5% SC containing xanthan gum.

| | | T = 3° C. | T = 54° C. |
|---|---|---|---|
| Concentrated | T = 0 | 7 days | 14 days |
| suspensions | M2 | M2 | M2 |
| Appearance | Homogeneous | Homogeneous | The formulation |
| | suspension | suspension | compacts and |
| | without | without | darkens on the |
| | phase separation | phase separation | surface. |
| | and sediments | and sediments | The rod passes |
| | | | through without |
| | | | difficulty when |
| | | | inserted. |
| | | | The presence of |
| | | | lumps is observed. |
| | | | Very viscous, |
| | | | which makes |
| | | | measurements |
| | | | from the next |
| | | | line of this |
| | | | table impossible. |
| Color | 608 U | 608 U | 608 U |
| Formulation | 5.99 | 5.89 | |
| pH | | | |
| Density | 1.2569 g/mL | 1.2512 g/mL | |
| Foam | Stops in less | Stops in less | |
| | than 10 seconds. | than 10 seconds. | |
| Viscosity | 25, 28 s | 28, 06 s | |
| Particle size | D 50: 1.235 | D 50: 1.469 | |
| | D 90: 2.875 | D 90: 3.102 | |
| | D 98: 4.698 | D 98: 4.900 | |
| 200 Mesh test | No waste | No waste | |
| Suspensibility | 91.54% | 90.23% | |

As noted, no difference is immediately displayed. However, there are significant distinctions in stability results, particularly at 54° C. As known by a person skilled in the art, mancozeb presents a significant increase in viscosity at high temperatures, so that at 54° C. it is very difficult for the product to be fluid, with low viscosity. As can be seen in M1 the viscosity can be measured, which does not occur in M2.

### Quarantine Results

For quarantine control, M1 formulations with hydroxyethyl cellulose and M2 with xanthan gum are divided into individual vials that are stored at room temperature and remain at rest for 6 months until the control date. The configuration for quarantine controls is described in table 7.

TABLE 7
configuration for quarantine controls of formulations M1
and M2.

| | M1 | |
|---|---|---|
| | (hydroxyethyl | M2 |
| | cellulose- | (xanthan |
| Period | HEC) | gum) |
| Week 1 | 1 Vial | 1 Vial |
| Week 2 | 1 Vial | 1 Vial |
| Week 3 | 1 Vial | 1 Vial |
| Week 4 | 1 Vial | 1 Vial |
| Month 2 | 1 Vial | 1 Vial |
| Month 3 | 1 Vial | 1 Vial |
| Month 4 | 1 Vial | 1 Vial |
| Month 5 | 1 Vial | 1 Vial |
| Month 6 | 1 Vial | 1 Vial |

Viscosity control measured in seconds is carried out on Ford Cup No. 4. The reference standards for this test are as follows:
CIPAC MT 22 VISCOSITY; and
IRAM 1109-A14 VISCOSITY DETERMINATION WITH THE FORD CUP.

### Results

Initially a vial is opened weekly, and after a month the vial is assessed monthly. Both formulations were assessed up to the sixth month and the results were compiled in table 8 below. As noted, although in M1 (HEC as thickener) the viscosity increases over time, this increase in viscosity remains fixed and can be measured constantly, and the product remains fluid. In M2 (xanthan gum as a thickener), on the other hand, the viscosity increases much more almost immediately and in the fourth week it can no longer be measured.

TABLE 8
Quarantine test results for formulations M1 and M2.

| Time | Vis-M1 | Vis-M2 |
|---|---|---|
| 1^{st} week | 38.19 | 102.25 |
| 2^{nd} week | 49.94 | 120.37 |
| 3^{rd} week | 39.81 | 163.78 |
| 4^{th} week | 59.38 | Unable to |
| | | measure |
| 2 months | 58.75 | Unable to |
| | | measure |
| 3 months | 64.54 | Unable to |
| | | measure |
| 4 months | 92.94 | Unable to |
| | | measure |
| 5 months | 68.22 | Unable to |
| | | measure |
| 6 months | 72.00 | Unable to |
| | | measure |

### CONCLUSION

As explained, the mancozeb formulation 44.5% SC with hydroxyethyl cellulose as a thickener is a more stable product than the mancozeb formulation 44.5% SC with xanthan gum.

This is because the viscosity with hydroxyethyl cellulose remains lower and more stable over time compared to the formulation containing xanthan gum.

This is observed in the stability results at 54° C. where the viscosity of the sample was so high that it could not be measured, while the results for the sample with hydroxyethyl cellulose showed more stable values. The same can be seen in the quarantine results, wherein the sample with xanthan gum showed very high viscosity values and in the fourth week it was so high that it could no longer be measured. In the sample with hydroxyethyl cellulose, in turn, it remained with reduced viscosity and more stable during the 6 months of testing.

It is to be understood that the present description does not limit the application to the details described herein and that the invention is capable of other embodiments and of being practiced or carried out in a variety of ways, within the scope of the claims. Although specific terms have been used, such terms should be construed in a generic and descriptive sense and not with the purpose of limitation.

1. An aqueous fungicide formulation in concentrated suspension, comprising the following components, in mass percentage (% m/m):
a) 30 to 50% of a dithiocarbamate fungicide;
b) 0.1 to 3% of an aliphatic ethoxylated alcohol of formula (I) 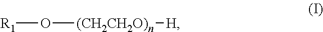
wherein R¹ is a linear or branched C₈-C₂₅ alkyl chain and “n” ranges from 1 to 10;
c) 0.1 to 3% of a block copolymer of polyethylene glycol and polypropylene glycol of formula (II) 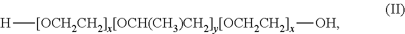
wherein “x” ranges from 80 to 135 and “y” ranges from 30 to 70;
d) 0.1 to 2% of hydroxyethyl cellulose;
e) 0.1 to 3% of an antifoam; and
f) 50 to 65% water,
whereby said formulation is free from any of the following components:
(A) polysaccharide gum;
(B) naphthalene derivatives;
(C) pH regulators;
(E) antifreeze;
(F) petroleum-derived hydrocarbons;
(G) lignosulfonate salts; and
(H) formaldehyde.

2. The aqueous fungicide formulation of claim 1, wherein the components are present in the following quantities (% m/m):
a) 35 to 45% of the dithiocarbamate fungicide;
b) 0.8 to 1.5% of the aliphatic ethoxylated alcohol of formula (I);
c) 0.8 to 1.5% of the block copolymer of polyethylene glycol and polypropylene glycol of formula (II);
d) 0.1 to 1% of the hydroxyethyl cellulose;
e) 0.1 to 1% of the antifoam; and
f) 55 to 60% of water.

3. (canceled)

4. (canceled)

5. The aqueous fungicide formulation of claim 1, wherein R¹ is a linear C₁₂-C₁₆ alkyl chain, “n” ranges from 1 to 3, “x” ranges from 95 to 100, and “y” ranges from 62 to 67.

6. The aqueous fungicide formulation of claim 1, wherein it further comprises a preservative in amounts between 0.001 and 0.01% by mass (% m/m).

7. (canceled)

8. (canceled)

9. The aqueous fungicide formulation of claim 1, wherein the dithiocarbamate is mancozeb.

10. (canceled)

11. (canceled)

12. (canceled)

13. The aqueous fungicide formulation of claim 6, wherein the preservative is 1,2-benzisothiazolin-3-one.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A production process of the aqueous fungicide formulation in concentrated suspension defined in claim 1, wherein it comprises the following steps:
a) in a formulating tank, adding water and start stirring using a mixer;
b) adding the aliphatic ethoxylated alcohol of formula (I) in the water, and keep stirring; obtaining a first mixture;
c) adding the block copolymer of polyethylene glycol and propylene glycol of formula (II) to the first mixture, and keep stirring; obtaining a second mixture;
d) adding the antifoam to the second mixture, and keep stirring; obtaining a third mixture;
e) adding the dithiocarbamate to the third mixture, said addition being carried out between 30 and 120 minutes, and keep stirring after the addition time of said dithiocarbamate; obtaining a fourth mixture;
f) grinding the fourth mixture for 60 to 180 minutes, said grinding being carried out at temperatures between 2° and 30° C., and said grinding being carried out at a rotation frequency between 20 and 80 Hz; obtaining a ground mixture comprising dithiocarbamate microparticles;
g) carrying out a preliminary quality control of the ground mixture, said quality control comprising a particle size analysis (d₉₈) and a 325 mesh test for the dithiocarbamate microparticles;
h) decide whether to repeat step (f) or proceed with step (i), said decision being based on the following conditions: if the particle size (d₉₈) is a value outside the range between 2 and 7 microns, repeat step (f); if the particle size (d₉₈) is 2 to 7 microns and the 325 mesh test shows zero or negligible retention of said microparticles, proceed with step (i);
i) adding the hydroxyethyl cellulose and the preservative to the mixture approved in step (h), and start stirring; obtaining the aqueous fungicide formulation in concentrated suspension; and
j) carrying out a general quality control comprising the measurement of physicochemical parameters selected from the group comprising color, pH, density, foam aspect, viscosity, particle size, 325 mesh test, 200 mesh test, level of suspension, mancozeb content, and stability at 54° C.

27. The production process of claim 26, wherein the stirring in steps (a), (b), (c), (d), (e), and (i) is carried out at speeds between 300 and 800 rpm, said stirring being carried out at a temperature of 13 to 37° C.

28. The production process of claim 26, wherein:
the stirring in steps (a), (b), and (c) is carried out for 1 to 40 minutes;
the stirring in step (d) is carried out for 1 to 20 minutes;
the stirring in step (e) is carried out for 3 to 120 minutes; and
the stirring in step (i) is carried out for 1 to 60 minutes.

29. The production process of claim 26, wherein:
the stirring in steps (a), (b), and (c) is carried out for 10 minutes;
the stirring in step (d) is carried out for 5 minutes;
the stirring in step (e) is carried out for 30 minutes; and
the stirring in step (i) is carried out for 15 minutes,
wherein the stirring in steps (a), (b), (c), (d), (e), and (i) is carried out at speeds between 300 and 400 rpm, said stirring being carried out at a temperature of 25° C.

30. The production process of claim 26, wherein:
in step (a) water is added in amounts between 55 and 60% (m/m);
in step (b) the aliphatic ethoxylated alcohol of formula (I) is added in amounts between 0.8 and 1.5% (m/m);
in step (c) the block copolymer of polyethylene glycol and propylene glycol of formula (II) is added in amounts between 0.8 and 1.5% (m/m);
in step (d) the antifoam is added in amounts between 0.1 and 1% (m/m);
in step (e) the dithiocarbamate is added in amounts between 35 and 45% (m/m); and
in step (i) the hydroxyethyl cellulose is added in amounts between 0.1 and 1% (m/m); and the preservative is added in quantities between 0.001 and 0.01% by mass (m/m).

31. The production process of claim 26, wherein:
in step (a) the water is added in an amount of 58% (m/m);
in step (b) the aliphatic ethoxylated alcohol of formula (I) is added in an amount of 1.3% (m/m);
in step (c) the block copolymer of polyethylene glycol and propylene glycol of formula (II) is added in an amount of 1.4% (m/m);
in step (d) the antifoam is added in an amount of 0.9% (m/m);
in step (e) the dithiocarbamate is added in an amount of 38.2% (m/m), said addition being carried out over 60 minutes;
in step (f) the grinding is carried out for 90 minutes, at a temperature of 25° C., and with a rotation frequency between 40 and 60 Hz; and
in step (i) the hydroxyethyl cellulose is added in an amount of 0.2% (m/m); and the preservative is added in an amount of 0.005% by mass (m/m).

32. A use of the aqueous fungicide formulation in concentrated suspension defined in claim 1, wherein it is for application to biological targets present in crops selected from the group comprising rice, banana, potato, citrus, bean, apple, corn, rose, soybean, tomato, wheat, grape, sugar cane, or cotton, wherein said biological targets are selected from the group comprising Pyricularia grisae, Mycosphaerella musicola, Mycosphaerella fijiensis, Alternaria solani, Phytophthora infestans, Phyllocoptruta oleivora, Diaporthe citri, Elsinoe australis, Colletotrichum lindemutianum, Venturia inaequalis, Colletotrichum gloeosporioides, Phaeosphaeria maydis, Diplocarpon rosae, Septoria glycines, Corynespora cassiicola, Alternaria solani, Bipolaris sorokiniana, Plasmopora viticola, Greeneria uvicola, Phakopsora pachyrhizi, Colletotrichum truncatum, Thielaviopsis paradoxa, Puccinia Kuehnii, Puccinia polysora, Cercospora zeae maydis, Corynespora cassiicola, or Ramularia areola.

33. (canceled)
